(19) United States
(12) Patent Application Publication
(10) Pub. No.: US 2018/0200995 A1
(43) Pub. Date: Jul. 19, 2018

(54) STRENGTHENED ASYMMETRIC GLASS LAMINATES

(71) Applicant: CORNING INCORPORATED, CORNING, NY (US)

(72) Inventors: Michael John MOORE, Corning, NY (US); Chad Michael WILCOX, Horseheads, NY (US)

(73) Assignee: CORNING INCORPORATED

(21) Appl. No.: 15/748,407

(22) PCT Filed: Jul. 28, 2016
(86) PCT No.: PCT/US2016/044415

§ 371 Date: Jan. 29, 2018

Related U.S. Application Data
(60) Provisional application No. 62/199,660, filed on Jul. 31, 2015.

(51) Int. Cl. B32B 17/10; B32B 7/02

(52) U.S. Cl. CPC B32B 17/10036; B32B 17/10137; B32B 17/10293; B32B 2605/00; B32B 17/10568; B32B 7/02; B32B 17/10155

(57) ABSTRACT

Embodiments of a laminate including a first glass ply having first and second opposing surfaces defining a first edge having a first thickness, a second glass ply having third and fourth opposing surfaces defining a second edge having a second thickness that is less than the first thickness, and a polymer layer disposed between the second surface of the first glass ply and the third surface of the second glass ply are disclosed. In one or more embodiments, the first edge comprises any one of a roughness Ra of less than about 1300 nm and a root mean square (RMS) roughness of less than about 1700 nm, as measured along an area of about 0.5 square millimeters (mm2). In some embodiments, the first edge is substantially free of conchoidal fractures having a major dimension greater than 20 micrometers, as measured along an area of 0.60 square micrometers. Vehicles including such laminates and methods for forming such laminates are also disclosed.

### CROSS-REFERENCE TO RELATED APPLICATIONS

This application claims the benefit of priority under 35 U.S.C. § 119 of U.S. Provisional Application Ser. No. 62/199,660, filed on Jul. 31, 2015, the content of which is relied upon and incorporated herein by reference in its entirety.

### BACKGROUND

The disclosure relates to strengthened asymmetrical glass laminates for use in vehicle glazing and more specifically to such laminates that include a first glass ply, a polymer layer and a second glass ply that is thicker than the first ply, wherein the second glass ply has an edge exhibiting low roughness and that is substantially free of long conchoidal fractures.

The desire to extend gas use efficiency in vehicles, especially passenger automobiles, has driven efforts to reduce the weight of such vehicles. In addition, there is a desire to enlarge the size of openings in some vehicles for aesthetic reasons and, thus the size of glazing used in such openings. Accordingly, one solution to meet both light-weighting and aesthetic needs is to reduce the thickness of glass used in vehicular glazing (or windows); however, this glazing must still meet governmental regulations and OEM requirements.

Currently, glass is primarily used in vehicles such as automobiles in the form of a monolith (i.e., a single ply) or a laminate that includes two glass plies and a polymeric layer disposed between the two glass plies. As used herein, “ply” or “plies” refers to glass having a sheet form. Typically the glass plies are annealed and comprise a soda lime glass. In a typical configuration, the thickness of both glass sheets is about 2.1 mm.

A reduction in the thickness of glass plies used in laminates has traditionally been thought to also cause reduction in mechanical reliability. Some challenging aspects that prevent OEMs from adopting thinner glass in glazing applications are wind load deflection, stiffness, ability to handle and install the glass without damage, and finally longevity of the glazing in the field.

Accordingly, there is a need to reduce the weight of glass being used in vehicles, while still maintaining or even exceeding the required mechanical performance.

### SUMMARY

A first aspect of this disclosure pertains to a laminate comprising a first glass ply, a second glass ply and a polymer layer disposed between the first glass ply and the second glass ply. In one or more embodiments, the first glass ply comprises first and second opposing surfaces defining a first edge having a first thickness, and the second glass ply comprises third and fourth opposing surfaces defining a second edge having a second thickness that is less than the first thickness, thus providing the asymmetry of the laminate (or an asymmetric laminate). In such embodiments, the polymer layer is disposed between the second surface of the first glass ply and the third surface of the second glass ply.

In one or more embodiments, the first edge (of the first glass ply) comprises a roughness Ra of less than about 1300 nm or less than about 1000 nm, as measured along an area of about 0.5 square millimeters (mm²). In some embodiments, the first edge comprises a root mean square (RMS) roughness of less than about 1700 nm, or less than about 1000 nm, as measured along an area of about 0.5 square millimeters (mm²).

In one or more embodiments, the first edge is substantially free of conchoidal fractures having a major dimension greater than 20 micrometers, as measured along an area of 0.60 square micrometers. In one or more embodiments, the first edge is substantially free of conchoidal fractures having a major dimension greater than 15 micrometers, as measured along an area of 0.60 square micrometers.

In one or more embodiments, the second thickness (of the second glass ply) is less than the first thickness (of the first glass ply). In some instances, the ratio of the first thickness to the second thickness is in a range from about 1.3:1 to 10:1. In one or more embodiments, the first thickness is greater than 1.6 mm (e.g., in a range from about 1.6 mm to about 3.0 mm or from about 1.6 mm to about 2.5 mm), and the second thickness is in a range from about 0.1 mm to up to about 1.6 mm (or from about 0.3 mm up to about 1.6).

In one or more embodiments, the polymer layer has a substantially constant thickness. In one or more embodiments, the polymer layer may have a wedged shape. In such embodiments, the polymer layer comprises a third edge with a third thickness and a fourth edge opposite the third edge with a fourth thickness greater than the third thickness.

In one or more embodiments, the second glass ply may be strengthened, while the first glass ply is unstrengthened. In one or more specific embodiments, the second glass ply is chemically strengthened, thermally strengthened, or mechanically strengthened. In some instances, the second glass ply may be chemically and thermally strengthened, thermally and mechanically strengthened, or chemically and mechanically strengthened.

In one or more embodiments, the first and second glass plies may be the same compositionally or may differ from one another compositionally. For example, the first glass ply may include a soda lime glass and the second glass ply may include an alkali aluminosilicate glass. In other examples, the first glass ply and the second glass plies may include differing alkali aluminosilicate glasses from one another. In other examples, the first glass ply and the second glass plies may include differing soda lime glasses from one another.

In one or more embodiments, the laminate may be complexly curved, as defined herein.

In one or more embodiments, the laminate may comprise a cold-formed laminate. In one or more embodiments, the second substrate is strengthened, the third surface comprises a third surface compressive stress and the fourth surface comprises a fourth surface compressive stress that is greater than the third surface compressive stress.

A second aspect of this disclosure pertains to a vehicle including a vehicle body; and at least one opening in the vehicle body, and a laminate (according to one or more of the embodiments described herein) disposed in the at least one opening. In one or more embodiments, the vehicle body defines an interior and the second glass ply faces the interior.

A third aspect of this disclosure pertains to a method of manufacturing a glass laminate. In one or more embodiments, the method includes removing at least one flaw in at least an edge of a thick glass ply to form a treated edge comprising one or both a roughness Ra of less than about 1300 nm, as measured along an area of about 0.5 square millimeters (mm²), a root mean square (RMS) roughness of less than about 1700 nm, as measured along an area of about 0.5 square millimeters (mm²) and, joining the glass ply to a polymer layer and a thin glass ply to form a laminate. In one or more embodiments, the thin glass ply is strengthened and has at thickness of less than about 1.6 mm. In one or more embodiments, the method may also include introducing the at least one flaw to the edge by separating the thick glass ply from a sheet. In one or more embodiments, removing the at least one flaw comprises grinding the edge with a wheel having an abradant finer than 220 grit or 400 grit or finer. In one or more embodiments, removing the at least one flaw comprises acid etching, mechanically polishing or acid etching and mechanically polishing the edge. In some embodiments, the treated edge is substantially free of conchoidal fractures having a major dimension greater than 20 micrometers, as measured along an area of 0.60 square micrometers. In some embodiments, the method may include encapsulating the laminate. In some embodiments, the method may include joining the laminate or the encapsulated laminate to a vehicle.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a side view of a laminate according to one or more embodiments;

FIG. 2 is a side view of a laminate according to one or more embodiments;

FIG. 3 is a side view of a complexly curved laminate according to one or more embodiments;

FIG. 4 is a graph showing the load to failure of the laminates having different thicknesses;

FIG. 5 is a graph showing stress on the second surface (of the first glass ply of the laminates of FIG. 4) and fourth surface (of the second glass ply of the laminates of FIG. 4) as the thickness of the second ply is reduced;

FIG. 6 is a Weibull probability plot of the failure at a given stress of a known laminate and a laminate according to one or more embodiments of this disclosure;

FIG. 7 shows the load to failure of a known laminate and laminates according to one or more embodiments;

FIG. 8 shows a vehicle including a laminate according to one or more embodiments

FIG. 9 shows a 3D image taken by a 3D Optical Surface Profiler of Comparative Example 1;

FIG. 10 shows a 3D image taken by a 3D Optical Surface Profiler of Example 2;

FIG. 11 shows a 3D image taken by a 3D Optical Surface Profiler of Example 3;

FIGS. 12A-12C show the surface image of the first edge of Comparative Examples 4A-4C;

FIGS. 12D-12F show the surface image of the first edge of Examples 4D-4F.

### DETAILED DESCRIPTION

Reference will now be made in detail to various embodiments, examples of which are illustrated in the accompanying drawings. Whenever possible, the same reference numerals will be used throughout the drawings to refer to the same or like parts.

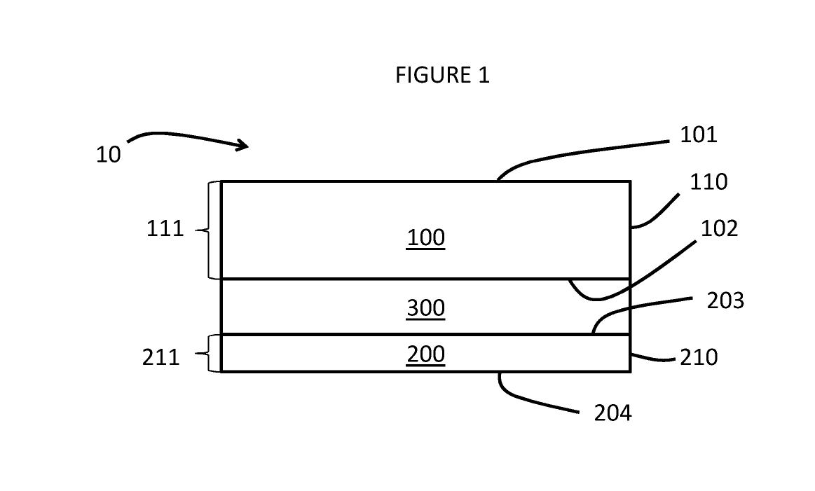

As shown in FIG. 1, a first aspect of this disclosure pertains to a laminate 10 having a first glass ply and a second glass ply having different thicknesses (i.e., asymmetry in thickness). Such laminates are referred to as asymmetric laminates due to such asymmetry in thickness between the glass plies. In one or more embodiments, the asymmetric laminate 10 may include a first glass ply 100, a second glass ply 200, and a polymer layer 300 disposed between the first and second glass plies. Specifically, the first glass ply 100 includes a first surface 101 and an opposing second surface 102, which constitute the major surfaces of the first glass ply, and which define a first edge 110 having a first thickness 111. The second glass ply 200 includes a third surface 203 and an opposing fourth surface 204, which constitute the major surfaces of the second glass ply, and which define a second edge 210 having a second thickness 211. The first thickness 111 is greater than the second thickness 211, in FIG. 1. As shown in FIG. 1, the polymer layer 300 is disposed between the first and second glass plies such that the polymer layer is in contact with the second surface 102 and third surface 203.

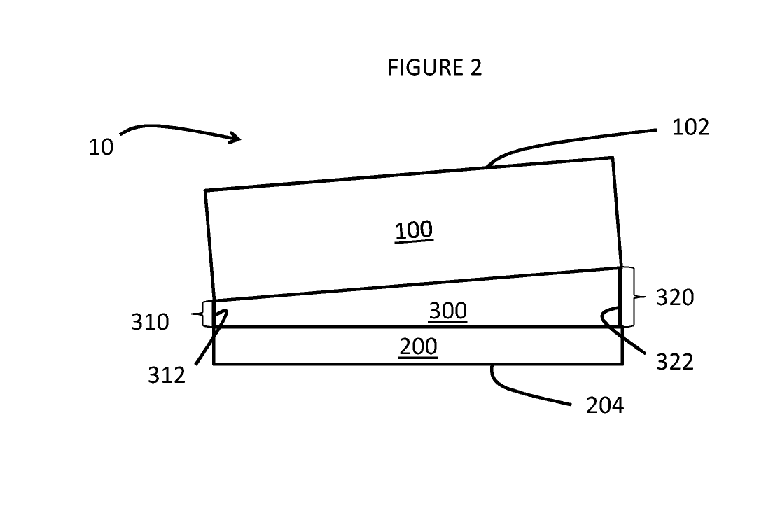

As also shown n FIG. 1, the polymer layer has a substantially constant thickness. In one or more embodiments, as shown in FIG. 2, the polymer layer may have a wedged shape. In such embodiments, the polymer layer 300 comprises a third edge 310 with a third thickness 312 and a fourth edge 320 opposite the third edge with a fourth thickness 312. The fourth thickness 312 is greater than the third thickness. When the laminate is assembled in a vehicle as a windshield, the fourth edge 320 is facing the roof, while the third edge 310 is facing the hood of the vehicle.

In one or more embodiments, the first glass ply has a first thickness in a range from about 1.6 mm to about 5 mm. For example, the first thickness may be in a range from about 1.6 mm to about 4.8 mm, from about 1.6 mm to about 4.6 mm, from about 1.6 mm to about 4.5 mm, from about 1.6 mm to about 4.4 mm, from about 1.6 mm to about 4.2 mm, from about 1.6 mm to about 4 mm, from about 1.6 mm to about 3.8 mm, from about 1.6 mm to about 3.6 mm, from about 1.6 mm to about 3.5 mm, from about 1.6 mm to about 3.4 mm, from about 1.6 mm to about 3.2 mm, from about 1.6 mm to about 3 mm, from about 1.6 mm to about 2.8 mm, from about 1.6 mm to about 2.6 mm, from about 1.6 mm to about 2.5 mm, from about 1.6 mm to about 2.4 mm, from about 1.6 mm to about 2.2 mm, from about 1.6 mm to about 2.1 mm, from about 1.8 mm to about 5 mm, from about 2 to about 5 mm, from about 2.1 mm to about 5 mm, from about 2.2 mm to about 5 mm, from about 2.4 mm to about 5 mm, from about 2.5 mm to about 5 mm, from about 2.6 mm to about 5 mm, from about 2.8 mm to about 5 mm, or from about 3 mm to about 5 mm.

In one or more embodiments, the second glass ply has a second thickness in a range from about 0.1 mm to up to about 1.6 mm. For example the second thickness may be in a range from about 0.1 mm to about 1.55 mm, from about 0.1 mm to about 1.5 mm, from about 0.1 mm to about 1.4 mm, from about 0.1 mm to about 1.3 mm, from about 0.1 mm to about 1.25 mm, from about 0.1 mm to about 1.2 mm, from about 0.1 mm to about 1.1 mm, from about 0.1 mm to about 1 mm, from about 0.1 mm to about 0.9 mm, from about 0.1 mm to about 0.8 mm, from about 0.1 mm to about 0.7 mm, from about 0.1 mm to about 0.6 mm, from about 0.1 mm to about 0.5 mm, from about 0.1 mm to about 0.4 mm, from about 0.1 mm to up to about 1.6 mm, from about 0.2 mm to up to about 1.6 mm, from about 0.3 mm to up to about 1.6 mm, from about 0.4 mm to up to about 1.6 mm, from about 0.5 mm to up to about 1.6 mm, from about 0.6 mm to up to about 1.6 mm, from about 0.7 mm to up to about 1.6 mm, from about 0.8 mm to up to about 1.6 mm, from about 0.9 mm to up to about 1.6 mm, from about 1 mm to up to about 1.6 mm, from about 1.1 mm to up to about 1.6 mm, from about 0.3 mm to about 0.7 mm, or from about 0.4 mm to about 0.7mm.

In one or more embodiments, the ratio of the first thickness (of the first glass ply) to the second thickness (of the second glass ply) may be in a range from about 1.3:1 to about 10:1. For example, the ratio may be in a range from about 1.3:1 to about 9:1, from about 1.3:1 to about 8:1, from about 1.3:1 to about 7:1, from about 1.3:1 to about 6:1, from about 1.3:1 to about 5:1, from about 1.3:1 to about 4:1, from about 1.3:1 to about 3:1, from about 1.3:1 to about 2:1, from about 1.4:1 to about 10:1, from about 1.5:1 to about 10:1, from about 1.6:1 to about 10:1, from about 1.7:1 to about 10:1, from about 1.8:1 to about 10:1, from about 1.9:1 to about 10:1, or from about 2:1 to about 10:1.

In one or more embodiments, the first glass ply and the second glass ply may include any one of a soda lime glass, an aluminosilicate glass, a borosilicate glass, a boroaluminosilicate glass, an alkali aluminosilicate glass, an alkali borosilicate glass or an alkali boroaluminosilicate glass. In some embodiments, the first glass ply and the second glass ply have substantially identical compositions or may have different compositions from one another. For example, the first glass ply may include a soda lime glass and the second glass ply may include an alkali aluminosilicate glass. In other examples, the first glass ply and the second glass plies may include differing alkali aluminosilicate glasses from one another. In other examples, the first glass ply and the second glass plies may include differing soda lime glasses from one another.

One example glass composition comprises SiO₂, B₂O₃ and Na₂O, where (SiO₂+B₂O₃)≥66 mol. %, and Na₂O≥9 mol. %. In an embodiment, the glass composition includes at least 6 wt. % aluminum oxide. In a further embodiment, the substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate can comprise 61-75 mol. % SiO2; 7-15 mol. % A₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrate comprises: 60-70 mol. % SiO₂; 6-14 mol. % A₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrate comprises: 63.5-66.5 mol. % SiO₂; 8-12 mol. % A₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for the substrate comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum modifiers} > 1 ,$$

where in the ratio the components are expressed in mol. % and the modifiers are alkali metal oxides. This glass composition, in particular embodiments, comprises: 58-72 mol. % SiO₂; 9-17 mol. % A₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers} > 1.$$

In still another embodiment, the substrate may include an alkali aluminosilicate glass composition comprising: 64-68 mol. % SiO₂; 12-16 mol. % Na₂O; 8-12 mol. % A₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)−A₂O₃≤2 mol. %; 2 mol. %≤Na₂O−A₂O₃≤6 mol. %; and 4 mol. %≤(Na₂O+K₂O)−A₂O₃≤10 mol. %.

In an alternative embodiment, the substrate may comprise an alkali aluminosilicate glass composition comprising: 2 mol % or more of A₂O₃ and/or ZrO₂, or 4 mol % or more of A₂O₃ and/or ZrO₂.

In some variants, the glass may be free of lithia.

In one or more embodiments, the second glass ply may be strengthened, while the first glass ply is unstrengthened. As used herein, a strengthened glass ply includes a surface compressive stress (CS) region or layer that extends from one or both major surfaces of the glass ply (e.g., 101, 102, 203, 204 from FIGS. 1-3), to a depth of compressive stress (DOC). The strengthened glass ply includes a corresponding central tension (CT) region in the core or central portion of the glass ply.

In one or more specific embodiments, the second glass ply is chemically strengthened, thermally strengthened, or mechanically strengthened. In some instances, the second glass ply may be chemically and thermally strengthened, thermally and mechanically strengthened, or chemically and mechanically strengthened. In some instances, the strengthened glass ply may be chemically and thermally strengthened, thermally and mechanically strengthened or chemically and mechanically strengthened. Mechanical strengthening is achieved by utilizing a mismatch of the coefficient of thermal expansion between portions of the glass ply to create CS and CT regions. Where thermal strengthening is used, the glass ply may be heated and then cooled using very high heat transfer rates (h in units of cal/cm²-s-C° in a precise manner to generate differential cooling rates between the surface portions of the glass ply and interior portions, thereby creating CS and CT regions. The glass ply may be chemically strengthened by an ion exchange process by which ions at or near the surface(s) of the glass ply are exchanged for larger metal ions (typically be immersing the glass ply in a molten salt bath containing having such larger ions). The incorporation of the larger ions into the glass ply creates a CS in a near surface region or in regions at and adjacent to the surface(s) and a CT region.

In one or more embodiments, both the first glass ply and the second glass ply are unstrengthened. As used herein, the term “unstrengthened” refers to a glass ply that is not chemically strengthened, not thermally strengthened or not mechanically strengthened but may be annealed. In some instances, one of the first or second glass ply is annealed, while the other glass ply is not annealed. In one or more embodiments, the first glass ply is annealed while second glass ply is strengthened (as described herein). In some embodiments, both the first glass ply and the second glass ply are strengthened.

Surface CS may be measured near the surface or within the strengthened glass at various depths. A maximum CS value may include the measured CS at the surface (CSₛ) of the strengthened substrate. The CT, which is computed for the inner region adjacent the compressive stress layer within a glass substrate, can be calculated from the CS, the physical thickness t, and the DOC. CS and DOC are measured using those means known in the art. by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to a modified version of Procedure C described in ASTM standard C770-98 (2013), entitled “Standard Test Method for Measurement of Glass Stress-Optical Coefficient,” the contents of which are incorporated herein by reference in their entirety. The modification includes using a glass disc as the specimen with a thickness of 5 to 10 mm and a diameter of 12.7 mm, wherein the disc is isotropic and homogeneous and core drilled with both faces polished and parallel. The modification also includes calculating the maximum force, Fmax to be applied. The force should be sufficient to produce at least 20 MPa compression stress. Fmax is calculated as follows:

Fmax=7.854*D*h
Where:
Fmax=Force in Newtons
D=the diameter of the disc
h=the thickness of the light path
   For each force applied, the stress is computed as follows:

σMPa=8F/(πL*D*h)
Where:
F=Force in Newtons
D=the diameter of the disc
h=the thickness of the light path

The relationship between CS and CT is given by the expression (1):

CT=(CS·DOL)/(t−2DOL) (1),

wherein t is the physical thickness (μm) of the glass article. In various sections of the disclosure, CT and CS are expressed herein in megaPascals (MPa), physical thickness t is expressed in either micrometers (μm) or millimeters (mm) and DOL is expressed in micrometers (μm).

In one embodiment, a strengthened substrate can have a surface CS about 100 MPa or greater, about 150 MPa or greater, about 200 MPa or greater, of 250 MPa or greater, 300 MPa or greater, e.g., 400 MPa or greater, 450 MPa or greater, 500 MPa or greater, 550 MPa or greater, 600 MPa or greater, 650 MPa or greater, 700 MPa or greater, or 750 MPa or greater. In one or more embodiments, the CS may be in a range from about 50 MPa to about 800 MPa (e.g., from about 50 MPa to about 700 MPa, from about 50 MPa to about 600 MPa, from about 50 MPa to about 500 MPa, from about 50 MPa to about 400 MPa, from about 50 MPa to about 300 MPa, from about 50 MPa to about 250 MPa, from about 100 MPa to about 800 MPa, from about 120 MPa to about 800 MPa, from about 150 MPa to about 800 MPa, from about 200 MPa to about 800 MPa, or from about 250 MPa to about 800 MPa. The strengthened substrate may have a DOL in the range from about 35 μm to about 200 μm (e.g., 45 μm, 60 μm, 75 μm, 100 μm, 125 μm, 150 μm or greater). In one or more specific embodiments, the strengthened substrate has one or more of the following: a surface CS of about 50 MPa to about 600 MPa, and a DOL in the range from about 30 μm to about 60 μm.

In such embodiments, either one or both of the glass plies exhibit an average transmittance over the wavelength range from about 420 nm to about 700 nm of about 85% or greater, about 86% or greater, about 87% or greater, about 88% or greater, about 89% or greater, about 90% or greater, about 91% or greater or about 92% or greater.

The glass plies may be formed using a variety of different processes. For instance, various forming methods include float glass processes and down-draw processes such as fusion draw and slot draw.

The polymer layer may include any one of the following materials: PVB (polyvinyl butyral), acoustic PVB, TPU (thermoplastic polyurethane), EVA (ethylene vinyl acetate) and DuPont™ SentryGlas® in non-limiting fashion. Thickness of the polymer layer may be in the range from about 0.38 mm to about 0.81 mm.

Examples of laminate constructions include the following:
For use in windshields:
   1.8-2.3 mm annealed second glass ply/polymer layer/0.3-1.0 mm chemically strengthened first glass ply
   1.8-2.3 mm annealed second glass ply/polymer layer/0.3-1.2 mm thermally strengthened first glass ply
   1.8-2.3 mm annealed second glass ply/polymer layer/1.0 mm annealed first glass ply
For sidelites:
   1.6-2.3 mm heat strengthened second glass ply/polymer layer/0.3-0.7 mm chemically strengthened first glass ply
   1.6-2.3 mm annealed second glass ply/polymer layer/0.3-1.2 mm thermally strengthened first glass ply
   1.6-2.3 mm heat strengthened second glass ply/polymer layer/1.0 mm annealed first glass ply
For use in backlites (or rear windshields):
   1.6-2.3 mm annealed second glass ply/polymer layer/0.3-0.7 mm chemically strengthened first glass ply
   1.6-2.3 mm annealed second glass ply/polymer layer/0.3-1.2 mm thermally strengthened first glass ply
   1.6-2.3 mm annealed second glass ply/polymer layer/1.0 mm annealed first glass ply
For use in sun roof/moon roof:
   1.6-2.1 mm annealed second glass ply/polymer layer/0.3-1.0 mm chemically strengthened first glass ply
   1.6-2.1 mm thermally strengthened second glass ply/polymer layer/0.3-1.0 mm chemically strengthened first glass ply
   1.6-2.3 mm annealed second glass ply/polymer layer/0.3-1.2 mm thermally strengthened first glass ply
   1.6-2.3 mm thermally second glass ply/polymer layer/0.3-1.2 mm thermally strengthened first glass ply
   1.6-2.1 mm annealed second glass ply/polymer layer/1.0 mm annealed first glass ply
   1.6-2.1 mm thermally strengthened second glass ply/polymer layer/1.0 mm annealed first glass ply

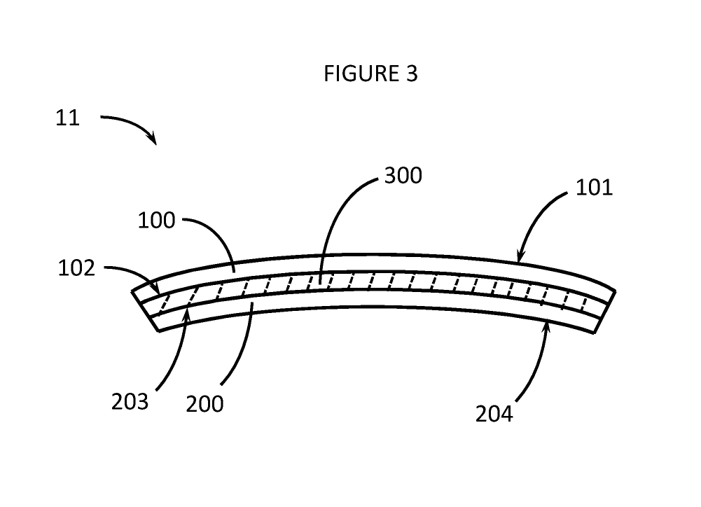

In one or more embodiments, the laminate may have a curvature that is imparted by bending or shaping the first and second glass plies. In some embodiments, the laminate is complexly curved or has a complexly curved shape, as described herein. In some embodiments, the laminate may have a flat shape or a cylindrically curved shape (as described herein). FIG. 3 illustrates one embodiment of a laminate 11 including a first glass ply 100 that is complexly curved and having at least one convex surface provided by a first surface 101 opposite at least one concave surface provided by a second surface 102. The laminate 11 also includes a second glass ply 200 that is complexly curved. The second substrate 200 includes at least one convex surface provided by a third surface 203 opposite at least one concave surface provided by a fourth surface 204. As shown in FIG. 3, a polymer layer 300 may be disposed between the first glass ply 100 and the second glass ply 200. As used herein, the term “convex surface” means outwardly bending or curving as shown in FIG. 2 at reference numbers 102 and 203. The term “concave surface” means inwardly bending or curving as shown in FIG. 3 at reference numbers 102, 204.

In one or more embodiments, the complexly curved laminate 11 may be formed using a cold-forming process. In one or more embodiments, prior to the cold-forming process, the respective compressive stresses in the third surface 203 and fourth surface 204 are substantially equal. In embodiments in which the second substrate 200 is unstrengthened (as defined herein), the third surface 203 and the fourth surface 204 exhibit no appreciable compressive stress, prior to cold-forming. In embodiments in which the second substrate 200 is strengthened (as described herein), the third surface 203 and the fourth surface 204 exhibit equal compressive stress with respect to one another, prior to cold-forming. In one or more embodiments, after cold-forming, the compressive stress on the fourth surface 204 increases (i.e., the compressive stress on the fourth surface 204 is greater after cold-forming than before cold-forming). In addition, the compressive stress on the fourth surface 204 is greater than the compressive stress in the third surface.

In one or more embodiments, the laminate has a complexly curved shape. As used herein “complex curve” and “complexly curved” mean a non-planar shape having curvature along two orthogonal axes that are different from one another. Examples of complexly curved shapes includes having simple or compound curves, also referred to as non-developable shapes, which include but are not limited to spherical, aspherical, and toroidal. The complexly curved laminates according to embodiments may also include segments or portions of such surfaces, or be comprised of a combination of such curves and surfaces. In one or more embodiments, a laminate may have a compound curve including a major radius and a cross curvature. A complexly curved laminate according to one or more embodiments may have a distinct radius of curvature in two independent directions. According to one or more embodiments, complexly curved laminates may thus be characterized as having “cross curvature,” where the laminate is curved along an axis (i.e., a first axis) that is parallel to a given dimension and also curved along an axis (i.e., a second axis) that is perpendicular to the same dimension. The curvature of the laminate can be even more complex when a significant minimum radius is combined with a significant cross curvature, and/or depth of bend. Some laminates may also include bending along axes that are not perpendicular to one another. As a non-limiting example, the complexly-curved laminate may have length and width dimensions of 0.5 m by 1.0 m and a radius of curvature of 2 to 2.5 m along the minor axis, and a radius of curvature of 4 to 5 m along the major axis. In one or more embodiments, the complexly-curved laminate may have a radius of curvature of 5 m or less along at least one axis. In one or more embodiments, the complexly-curved laminate may have a radius of curvature of 5 m or less along at least a first axis and along the second axis that is perpendicular to the first axis. In one or more embodiments, the complexly-curved laminate may have a radius of curvature of 5 m or less along at least a first axis and along the second axis that is not perpendicular to the first axis.

In one or more embodiments, the laminate has a cylindrical shape. As used herein, the phrase “cylindrical shape” means a shape having a curvature along a single axis only. In some embodiments, the laminate has a substantially flat shape (i.e., having a radius of curvature of greater than or equal to about 3 meters, greater than or equal to about 4 meters or greater than or equal to about 5 meters).

In one or more embodiments, the laminate has a flat or planar shape. As used herein, “flat” and “planar” are used interchangeably and mean a radius of curvature of greater than or equal to about 3 meters, greater than or equal to about 4 meters or greater than or equal to about 5 meters.

In accordance with one or more embodiments, the laminates described include a first glass ply that is characterized by a 4-point edge strength of 128 MPa or higher (e.g., in the range from about 128 MPa to about 400 MPa, from about 130 MPa to about 400 MPa, from about 150 MPa to about 400 MPa, from about 200 MPa to about 400 MPa, from about 128 MPa to about 300 MPa, from about 128 MPa to about 200 MPa), measured according to ASTM C 158-02.

To withstand the stress of installation, laminates according to one or more embodiments exhibit a strength of greater than 35 lbf or greater than 60 N, measured with a three-point bend test (described herein). In one or more embodiments, windshield laminates exhibit a strength of greater than 35 lbf or greater than 60 N, measured with a three-point bend test.

For crash safety, one or more embodiments of the laminates have a passing value for the head injury criterion (HIC) of less than 1000. In some embodiments, such laminates comprise windshield laminates.

In one or more embodiments, the laminates described herein comprise side-lite laminates that withstand, in Door Slam Durability testing, 84,000 door slam cycles at 1.5 m/s testing speed.

The three-point bend testing references herein is used to evaluate the “load to failure” of the laminates described herein. The three-point bend test utilizes two lower support points that rest on the bottom of the glass ply or laminate, and one support point on the top of the glass ply or laminate. A load is applied to the glass ply or laminate by pinching the top and bottom support points. This action slowly increases the stress on the glass ply or laminate until the glass fractures, and the peak load is recorded. This test is meant to predict performance of the laminate as a function of its edge strength. Edge strength is useful in determining a laminate's suitability in manufacturing and use in various applications, including automotive, architectural and the like. In various embodiments, laminates meet this performance test by exhibiting a peak load (load to failure) of equal to or in excess of 35 pounds, or equal to or greater than 60 N, when tested with the machine used in the three-point test.

The four-point bend test referenced herein is similar to the three-point bend test but uses two supports above the glass ply or laminate and two supports below the glass ply or laminate. Four-point mechanical bend testing is carried out per ASTM Test C 158-02.

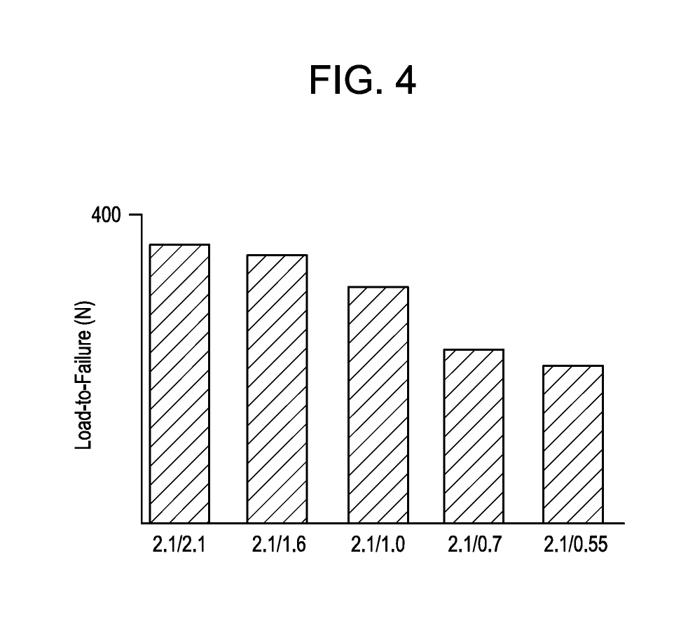

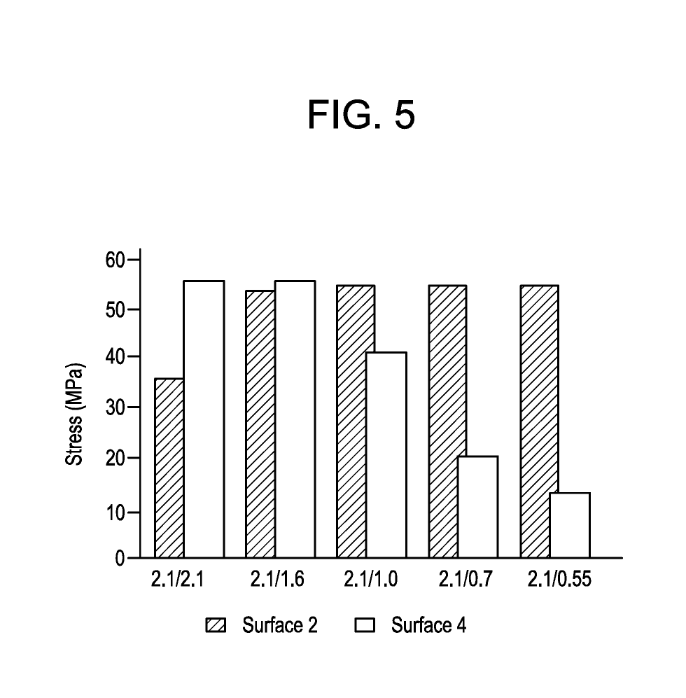

When testing thinner structures such as the embodiments of the laminates described herein, it is intuitive to expect such thin laminates to be less stiff than thicker structures. It is also intuitive to expect that, of the two plies, the thinner glass ply (i.e., the second glass ply) would be the weaker of the two glass plies. Indeed, the thicker first glass ply is stiffer than the thinner second glass ply. However, it is easier to deflect the thinner second glass ply (given sufficient edge strength of the thin ply to avoid breakage). This in turn concentrates the deflection forces on the thicker first glass ply. The additional stress on the thick first glass ply can cause it to fail prematurely during testing. FIGS. 4 and 5 demonstrate load failure is driven by total glass thickness of the laminate and the symmetry of the glass ply thickness. As shown in FIGS. 4-5, the load to failure of laminates having the following constructions was evaluated by the four-point bend: 2.1 mm-thick first glass ply/PVB polymer layer/2.1 mm thick second glass ply, 2.1 mm-thick first glass ply/PVB polymer layer/1.6 mm thick second glass ply, 2.1 mm-thick first glass ply/PVB polymer layer/1 mm thick second glass ply, 2.1 mm-thick first glass ply/PVB polymer layer/0.7 mm thick second glass ply, and 2.1 mm-thick first glass ply/PVB polymer layer/0.55 mm thick second glass ply.

As shown in FIG. 4, the laminate construction of 2.1 mm thick first glass ply/PVB polymer layer/0.7 mm thick second glass ply, exhibited a 36% lower load to failure than the thicker laminate construction of 2.1 mm-thick first glass ply/PVB polymer layer/1.6 mm thick second glass ply. Accordingly, while it is intuitive that the thinner laminate (i.e., 2.1 mm thick first glass ply/PVB polymer layer/0.7 mm thick second glass ply) is less stiff than the thicker laminate (i.e., 2.1 mm thick first glass ply/PVB polymer layer/1.6 mm thick second glass ply) and thus breaks under a lower stress, when this thinner laminate is subjected to testing measuring edge strength (i.e., the three-point bend test or the four-point bend test), it is not the thinner first glass ply that breaks first but, rather, the thicker second glass ply. Since the glass plies are bonded together with a polymer layer, both the first glass ply and the second glass ply bend to approximately the same radius curvature under a given load. For a given radius of curvature, the thicker first glass ply experiences a higher maximum principal stress from bending than the thinner first glass ply.

For these reasons, various embodiments of this disclosure pertain to preventing the thicker first glass ply (when assembled in the thinner laminates described herein) from breaking under the stresses and loads that the thicker laminates survive.

To determine the cause of the reduction in load to failure of thinner laminates versus thicker laminates, the stress on each of the glass plies was evaluated as the thickness of the second glass ply is reduced. FIG. 5 shows that stress on the second glass ply of the laminate is reduced as the thickness of the second glass ply is reduced, while the maximum principle stress on the thicker first glass ply increases. Moreover, FIG. 5 shows the relative stress, at laminate failure, for the first glass ply as measured on its exposed second surface 102 and the second glass ply as measured on its exposed fourth surface 204. Accordingly, since the first glass ply experiences higher stress, the embodiments described herein mitigate the effects of this higher stress on the thicker first glass ply.

Specifically, in one or more embodiments, the laminates described exhibit reduced flaws in the first edge of the thicker first glass ply to mitigate the effects of the higher stress on the thicker first glass ply. Reduction of such flaws in the first glass ply increases the strength of the laminate because such flaws are believed to grow and lead to failure or breakage upon application of stress (as illustrated by the three or four point bend test). As will be described herein the reduction of flaws may be accomplished by subjecting the first edge by grinding the first edge using mechanical grinding using a finer than 220 grit abradant (e.g., a 400 grit abradant on a grinding wheel), by chemically methods (i.e., acid edge) and by mechanical polishing. The resulting first edge will have attributes such as roughness or the absence of certain flaws that demonstrate the removal of such flaws.

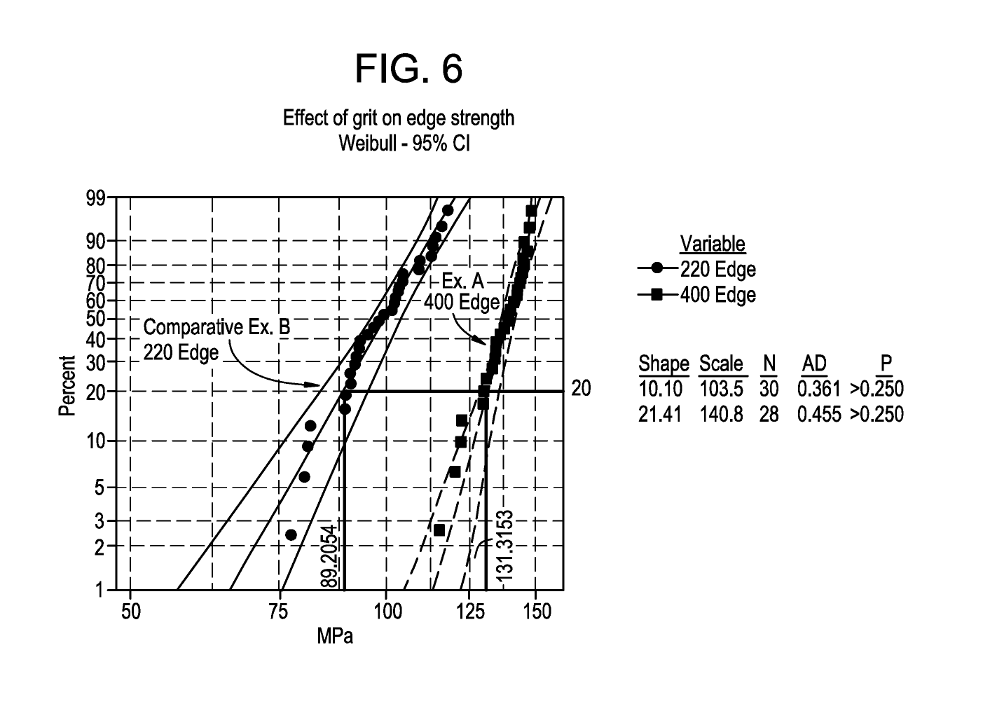

FIG. 6 compares the edge strength of a laminate according to one or more embodiments of this disclosure (Example A) and a known laminate (Comparative Example B). Example A and Comparative Example B had identical constructions, however, the first edge of the first glass ply of Example A was treated or abraded a 400 grit abradant, while the first edge of the first glass ply of Comparative Example B was treated with 220 grit abradant. FIG. 6 shows the probability of failure at a given stress for Example A and Comparative Example B a. According to FIG. 6, there exists a 20% probability that Comparative Example B will fail at a load of 89 MPa under a four-point bend test, while the same 20% probability of failure is only exhibited by Example A at a load of 131 MPa under the same four-point bend test.

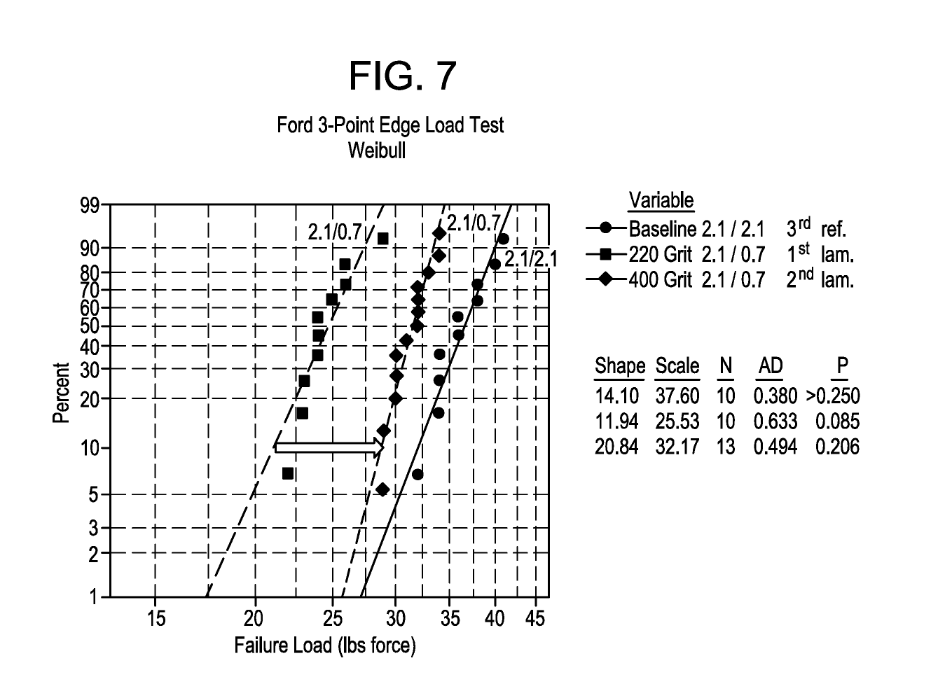

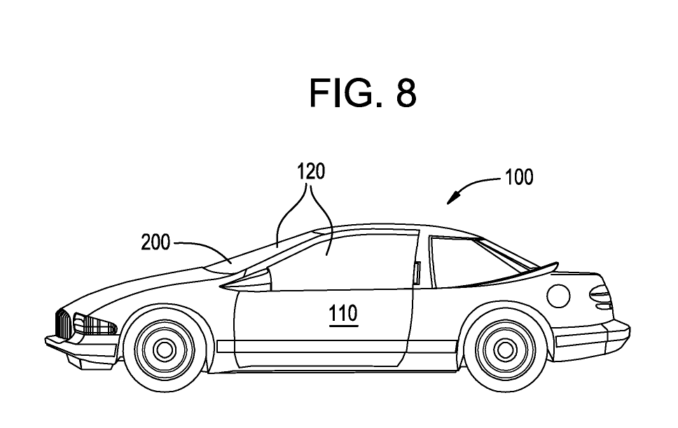

FIG. 7 shows the load to failure under a three point bend test for a first laminate having a 2.1 mm thick first glass ply/polymer layer/0.7 mm thick second glass ply, a second laminate having the same construction as the first laminate, and a third reference laminate having a 2.1 mm thick first glass ply/polymer layer/2.1 second glass ply. The first edge of the first glass ply of the first laminate was subjected grinding using a 220 grit abradant, while the first edge of the first glass ply of the second laminate was subjected to grinding using a 400 grit abradant. The third reference laminate was not subjected to any grinding, but included a significantly thicker second glass ply. The data show in FIG. 7 shows the thinner and asymmetric first and second laminates exhibit increased load to failure as measured by three-point bend test, and such load to failure approaches the load to failure of the third (thicker and symmetric) reference laminate.

Without being bound by theory, the three-point bend test duplicates the stresses induced on windshield laminates during installation into their respective auto frames. By virtue of their decreased thickness, the asymmetric laminates described herein experience greater deflection per unit load than their thicker laminate counterparts. As such, during mechanical testing greater stresses are induced in thinner laminates attributable to the tighter bend radius associated with the greater deflection.

In various embodiments, the first edge of one or more embodiments may be described in terms of its roughness or lack of specific flaws. Such attributes distinguish the first edge as having a surface or roughness profile that differs from the profile of edges treated with the known conventional grinding methods (e.g., methods that use 180 grit abradants or 220 grit abradants on a grinding wheel). Surface roughness of the first edge reflects the average flaw size and frequency thereof on the surface under evaluation. Flaw size and depth contribute to edge strength and can be expressed by a measure of subsurface damage. Without being bound by theory, there is a correlation between surface roughness parametrics (e.g., roughness Ra or root mean square roughness) and the size of the flaws, and edge and laminate strength. For example, a first edge treated with a known 220 grit abradant will leave larger, deeper flaws (having a greater depth of damage) if the first edge was treated with a finer abradant, such as a 400 grit abradant. Consequently, a first edge treated with a 220 grit abradant will exhibit a weaker mechanical edge strength than the same first edge treated with a 400 grit abradant.

The first edge of one or more embodiments may have a roughness Ra of 1300 nm or less, as measured over an area of about 0.5 square millimeters (mm²). In one or more embodiments, the first edge exhibits a roughness Ra along this area of about 1250 nm or less, about 1200 nm or less, about 1100 nm or less, about 1050 nm or less, about 1000 nm or less, about 950 nm or less, about 900 nm or less, about 850 nm or less, about 800 nm or less, or about 750 nm or less. In some embodiments, the roughness Ra as measured along this area may be in the range from about 500 nm to up to about 1300 nm, from about 500 nm to about 1250 nm, from about 500 nm to about 1200 nm, from about 500 nm to about 1150 nm, from about 500 nm to about 1100 nm, from about 500 nm to about 1050 nm, from about 500 nm to about 1000 nm, from about 500 nm to about 950 nm, from about 500 nm to about 900 nm, from about 500 nm to about 850 nm, from about 550 nm to up to about 1300 nm, from about 600 nm to up to about 1300 nm, from about 650 nm to up to about 1300 nm, from about 700 nm to up to about 1300 nm, from about 750 nm to up to about 1300 nm, from about 800 nm to up to about 1300 nm, from about 850 nm to up to about 1300 nm, from about 900 nm to up to about 1300 nm, from about 950 nm to up to about 1300 nm, from about 1000 nm to up to about 1300 nm, from about 500 nm to up to about 800 nm, from about 600 nm to up to about 750 nm, or from about 650 nm to up to about 800 nm. The roughness Ra described herein may be measured by an optical surface profiler, such as the 3D Optical Surface Profiler available from Zygo Corporation.

In one or more embodiments, first edge comprises a root mean square (RMS) roughness of less than about 1700 nm, as measured along an area of about 0.5 square millimeters (mm²). For example, the first edge may exhibit a RMS roughness along this area of about 1650 nm or less, about 1600 nm or less, about 1550 nm or less, about 1500 nm or less, about 1450 nm or less, about 1400 nm or less, about 1350 nm or less, about 1300 nm or less, about 1250 nm or less, about 1200 nm or less, about 1150 nm or less, about 1100 nm or less, about 1000 nm or less, about 950 nm or less, about 900 nm or less, about 850 nm or less, about 800 nm or less, about 750 nm or less, or about 700 nm or less. In one or more embodiments, the RMS roughness along this area may be in a range from about 700 nm to up to about 1700 nm, from about 700 nm to about 1650 nm, from about 700 nm to about 1600 nm, from about 700 nm to about 1550 nm, from about 700 nm to about 1500 nm, from about 700 nm to about 1450 nm, from about 700 nm to about 1400 nm, from about 700 nm to about 1350 nm, from about 700 nm to about 1300 nm, from about 700 nm to about 1250 nm, from about 700 nm to about 1200 nm, from about 700 nm to about 1150 nm, from about 700 nm to about 1100 nm, from about 700 nm to about 1050 nm, from about 700 nm to about 1000 nm, from about 700 nm to about 950 nm, from about 700 nm to about 900 nm, from about 700 nm to about 850 nm, from about 750 nm to up to about 1700 nm, from about 800 nm to up to about 1700 nm, from about 850 nm to up to about 1700 nm, from about 900 nm to up to about 1700 nm, from about 950 nm to up to about 1700 nm, from about 1000 nm to up to about 1700 nm, from about 1050 nm to up to about 1700 nm, from about 1100 nm to up to about 1700 nm, from about 1150 nm to up to about 1700 nm, from about 1200 nm to up to about 1700 nm, from about 1250 nm to up to about 1700 nm, from about 1300 nm to up to about 1700 nm, from about 1350 nm to up to about 1700 nm, or from about 1400 nm to up to about 1700 nm. The roughness RMS described herein may be measured by an optical surface profiler, such as the 3D Optical Surface Profiler available from Zygo Corporation.

In one or more embodiments, the first edge is substantially free of conchoidal fractures having a major dimension greater than 20 micrometers, as measured along an area of 0.60 square micrometers. In one or more embodiments, the first edge is substantially free of conchoidal fractures having a major dimension greater than 18 micrometers, greater than 16 micrometers, greater than 15 micrometers, greater than 14 micrometers, greater than 13 micrometers, or greater than 12 micrometers as measured along an area of 0.60 square micrometers. As used herein, “conchoidal fractures” mean fractures resembling rippling and gradual curves, which do not do not follow any natural planes of separation. The major dimension of such fractures is the longest dimension of the fractures, regardless of whether the fractures have a circular, oval-like, square-like, or other irregular shape. The dimension of conchoidal fractures are measured by imaging using a microscope, such as the InfiniteFocus microscope, supplied by Alicona Imaging GmbH, at a magnification of 50×.

In one or more embodiments, the laminates described herein are encapsulated. Encapsulation of such laminates, especially when used in back-lite and roof-lite laminates, imparts a stress induced by pressure and temperature while flowing inorganic material over the glass edges. This stress is insignificant for thick laminates as such laminates exhibit a greater stiffness than the thin laminates described herein; however, such stress may be significant for thinner laminates. One or more embodiments of the laminates described herein are able to withstand such stresses (due at least in part to the strength of the first edge).

In one or more embodiments, the laminate is provided in the shape of a vehicle windshield, a vehicle side light, a vehicle back light, or a vehicle roof light, to give non-limiting examples. Exemplary constructions of such laminates (in terms of thickness and arrangement of plies and layers) are described above and herein.

A second aspect of this disclosure pertains to a vehicle including a laminate, as described herein. An example of a vehicle 1000 that includes an embodiment of the laminates 10 described herein is shown in FIG. 7. The vehicle 1000 includes a body 1100 with at least one opening 2000. The laminate 10 is disposed in the at least one opening 2000. As used herein, the term “vehicle” may include automobiles (e.g., cars, vans, trucks, semi-trailer trucks, buses and motorcycles), seacraft, railcars aircraft (planes, helicopters, drones, and the like), and the like. The opening 2000 is a window within which a laminate is disposed to provide a transparent covering. It should be noted that the laminates described herein may be used in architectural panels such as windows, interior wall panels, modular furniture panels, backsplashes, cabinet panels, and/or appliance panels.

A third aspect of this disclosure pertains to a method of manufacturing the embodiments of the laminates described herein. In one or more embodiments, the method includes manufacturing process that are applied to a thick glass ply (e.g., the first glass ply)) of a laminate, after at least one flaw is introduced to at least edge (e.g., the first edge) of the thick glass ply. In one or more embodiments, the at least one flaw is introduced after separating the thick glass ply from a sheet. Such separation may include cutting the thick glass ply from a larger sheet. In some embodiments, the separation may include scoring and breaking the thick glass ply from a larger sheet.

In one or more embodiments, the method includes removing the at least one flaw in the edge of the thick glass ply to form a treated edge comprises one or both a roughness Ra of less than about 1300 nm, as measured along an area of about 0.5 square millimeters (mm²), and a root mean square (RMS) roughness of less than about 1700 nm, as measured along an area of about 0.5 square millimeters (mm²). Specifically, in one or more embodiments includes removing the at least one flaw of the first edge of the first glass ply to form a treated first edge comprising the roughness profiles described herein in terms of roughness Ra, RMS roughness and conchoidal fracture dimension. For example, the treated first edge may exhibit one or more of a roughness Ra of less than about 1300 nm, as measured along an area of about 0.5 square millimeters (mm²), and a root mean square (RMS) roughness of less than about 1700 nm, as measured along an area of about 0.5 square millimeters (mm²). In one or more embodiments, the treated edge is substantially free of conchoidal fractures having a major dimension greater than 20 micrometers, as measured along an area of 0.60 square micrometers.

In one or more embodiments, removing the at least one flaw from the thick edge (or first edge) comprises grinding the edge with a wheel having an abradant finer than 220 grit. In one or more embodiments, the abradant may be 400 grit or finer. In one or more embodiments, removing the at least one flaw comprises acid etching, mechanically polishing or acid etching and mechanically polishing the edge. In one or more embodiments, reducing the edge flaws comprises a combination of any two or more of grinding, acid etching, and polishing.

In one or more embodiments, the method includes joining the joining the glass ply comprising the treated edge to a polymer layer and a thin glass ply, wherein the thin glass ply is strengthened and has at thickness of less than about 1.6 mm In one or more embodiments, the method includes joining the glass ply comprising the treated edge to the polymer layer and the thin glass ply such that the polymer layer is between the glass plies. In one or more embodiments, the method includes removing the at least one flaw before the glass ply is joined to the polymer layer and the thin glass ply. In one or more embodiments, the method includes removing the at least one flaw after the glass ply is joined to the polymer layer and the thin glass ply.

In embodiments, the method may include separating the thick glass ply (or first glass ply) from a larger sheet using laser processing to introduce fewer flaws into the edge of the cut glass ply than using known methods. Methods of laser processing glass by chamfering or beveling an edge of a glass substrate can be found in International Application PCT/US2015/013026 filed Jan. 27, 2015, the disclosure of which is incorporated by reference. Any present flaws may then be further reduced by the methods described here (i.e., grinding, acid etching, and/or polishing). In one or more embodiments, the method may include laser processing along with removing the at least one flaw described herein (i.e., by grinding, acid etching and/or polishing). In some embodiments, removing the at least one flaw may include any two or more of grinding, acid etching, and polishing in combination with laser processing.

Removing the at least one flaw described herein (e.g., polishing, laser processing, etching, and grinding) serve to decrease maximum flaw size and depth of any flaws present in the edge of the thick glass ply. Edge polishing can be viewed as an extension of grinding and is typically applied sequentially to further reduce depth of damage incurred by upstream grinding. Acid etching may include application of an acid (e.g., HF acid) to decrease flaw size and depth and blunt medial crack tips in the edge.

In an embodiment, grinding with a finer grit from normal seamed, 180 grit or 220 grit wheel, which are traditionally used in the automotive processing, is used to strengthen the thick glass ply by removing the at least one flaw present in an edge. This step can result in an 35% or greater increase in strength in the thick glass ply

### EXAMPLES

Various embodiments will be further clarified by the following examples.

### Comparative Example 1

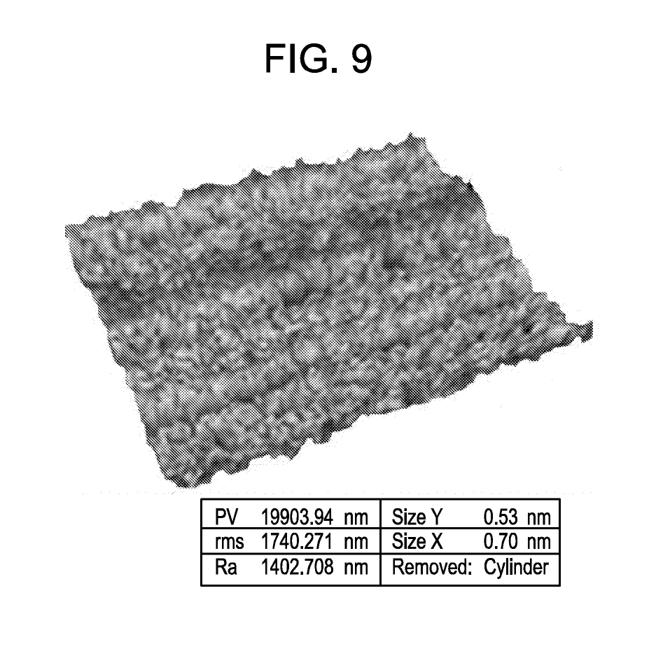

Comparative Example 1 was a first glass ply including a thickness of 2.1 mm and having a soda lime glass composition. The first edge of the first glass ply was treated with a grinding wheel including a 220 grit abradant. A portion of the first edge having dimensions 0.53 mm and 0.70 mm was analyzed by a 3D Optical Surface Profiler available from Zygo Corporation. The resulting 3D image is shown in FIG. 9 along with the measured roughness Ra of 1402.708 nm and RMS roughness of 1748.271 nm.

### Example 2

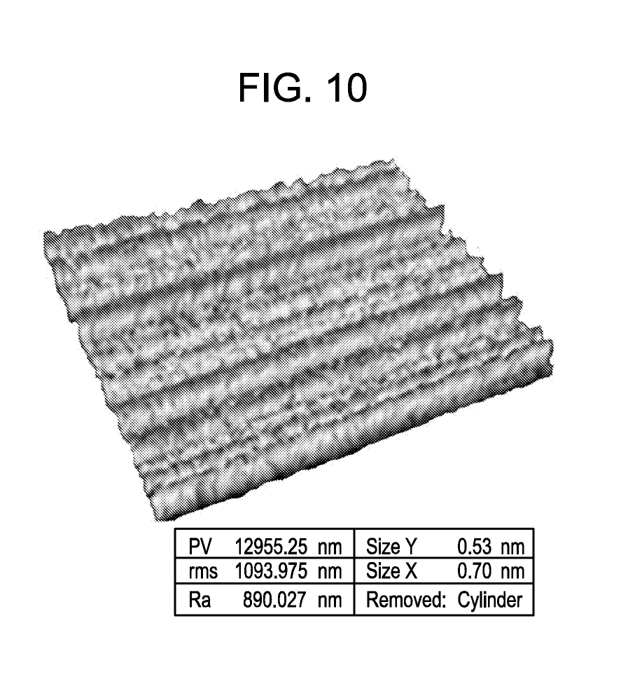

Example 2 was an identical first glass ply to the ply used in Comparative Example 1, however, first edge of the glass ply of Example 2 was treated with a grinding wheel including a 400 grit abradant. A portion of the first edge having dimensions 0.53 mm and 0.70 mm was analyzed by a3D Optical Surface Profiler available from Zygo Corporation. The resulting 3D image is shown in FIG. 10 along with the measured roughness Ra of 890.027 nm and RMS roughness of 1093.975 nm.

### Example 3

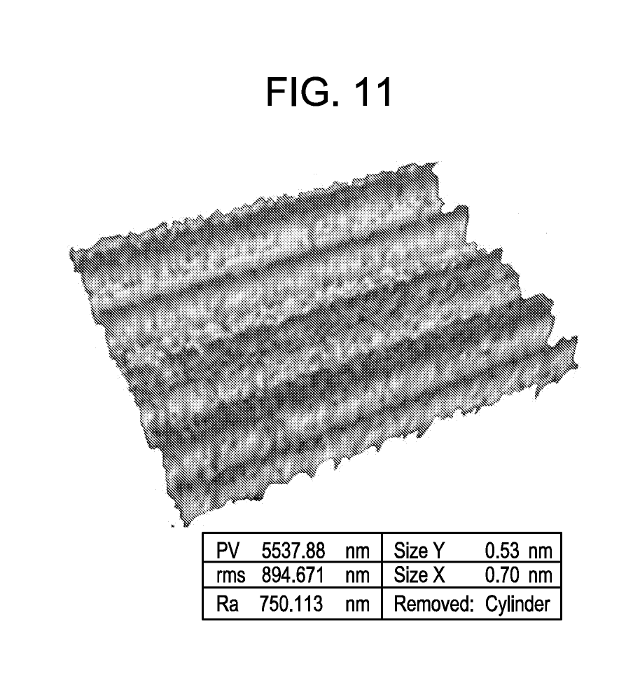

Example 3 was an identical first glass ply to the ply used in Comparative Example 1, however, first edge of the glass ply of Example 3 was treated with a grinding wheel including a 400 grit abradant. A portion of the first edge having dimensions 0.53 mm and 0.70 mm was analyzed by a3D Optical Surface Profiler available from Zygo Corporation. The resulting 3D image is shown in FIG. 11 along with the measured roughness Ra of 750.113 nm and RMS roughness of 894.671 nm.

### Example 4

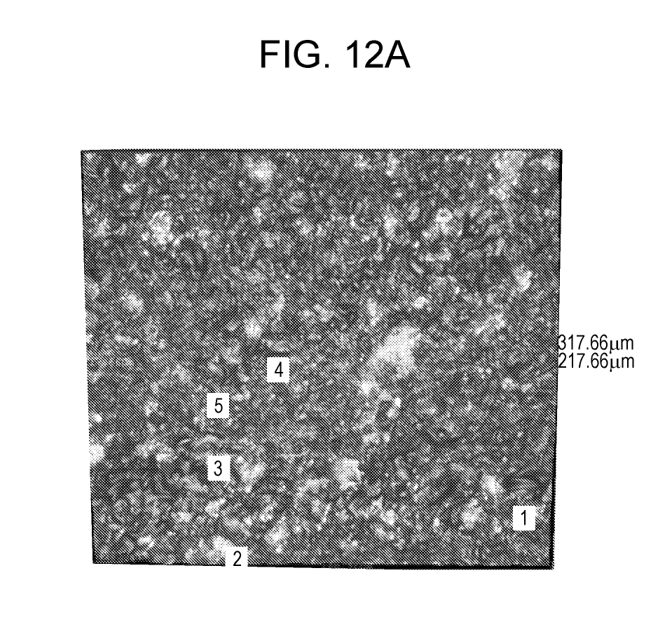

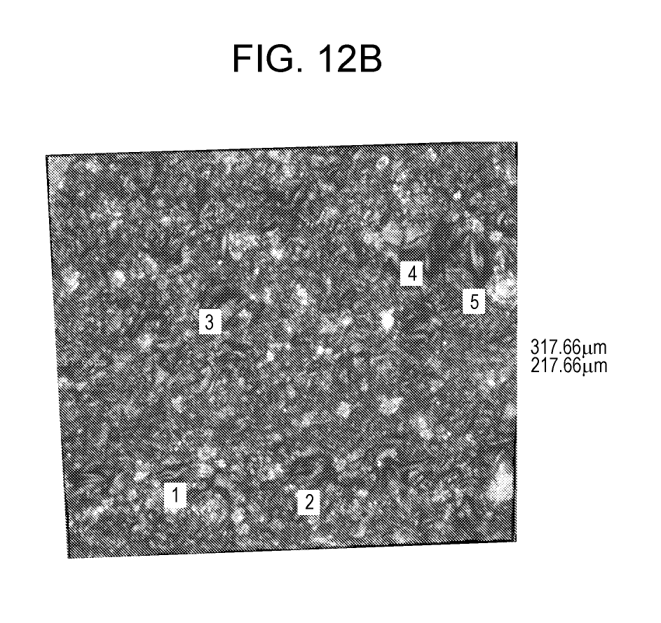

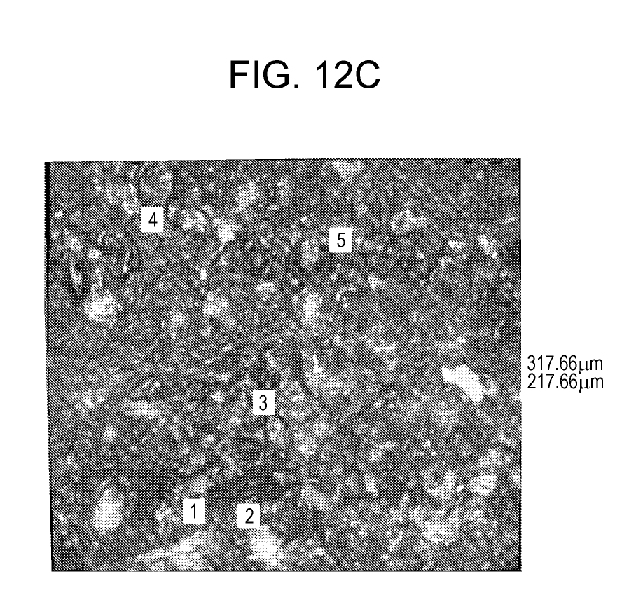

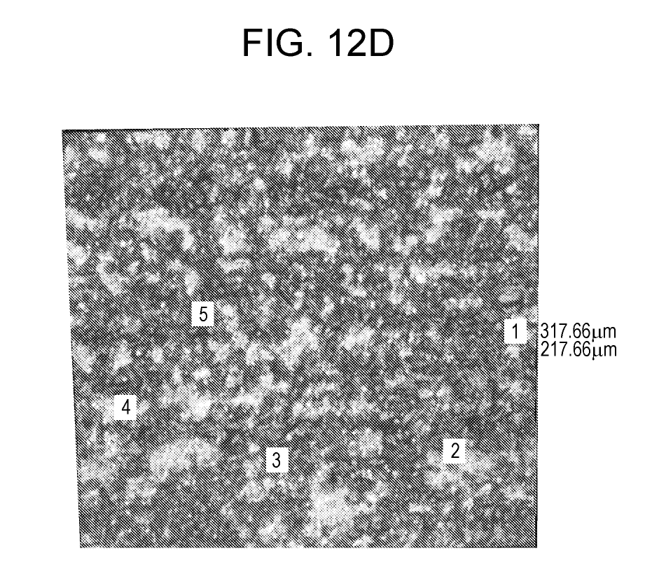

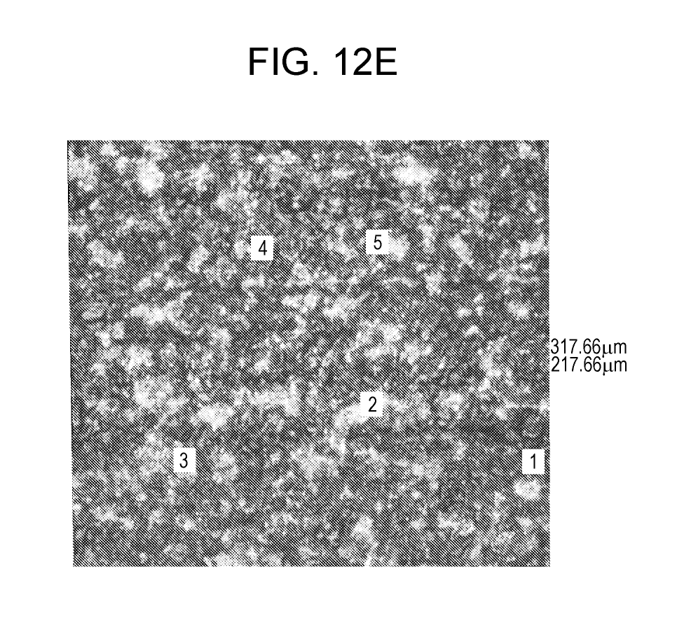

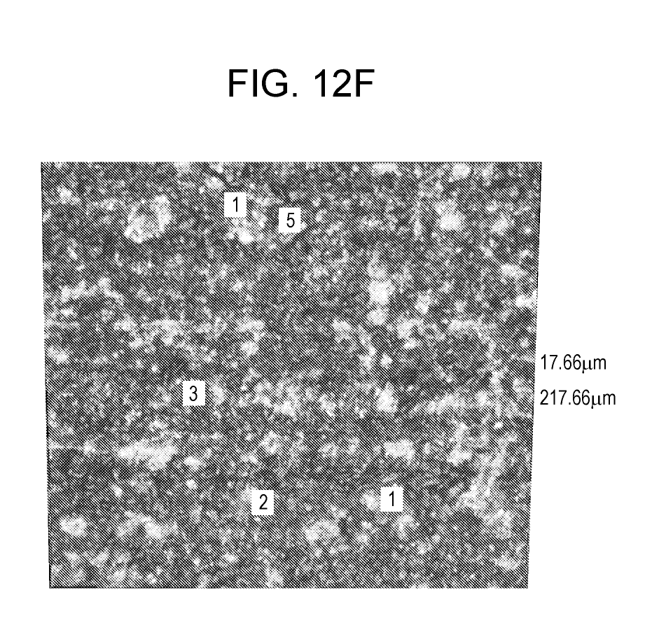

Comparative Examples 4A-4C and Examples 4D-4F were soda lime glass plies having a thickness of 2.1 mm. The first edge of each of the glass plies was treated with a grinding wheel including a 220 grit abradant (Comparative Examples 4A-4C) or 400 grit abradant (Examples 4D-4F). FIGS. 12A-12C shows the surface image of the first edge of the glass plies treated with a 220 grit abradant taken by a microscope at 50x magnification. FIGS. 12D-12F shows the surface image of the first edge of the glass plies treated with a 400 grit abradant taken by a microscope at 50× magnification.

The conchoidal fractures over a sample size of 286.92 micrometers by 217.66 micrometers (i.e., 0.6245 mm²) of each treated edge were evaluated and are identified sequentially as #1-#5 (which are also labeled in FIGS. 12A-12F). The relative sizes of each of the fractures #1-#5 are shown in Table 1. The average major dimension of the conchoidal fractures of Comparative Examples 4A-4C was 20.1 micrometers, with a standard deviation of 3.0. The average major dimension of the conchoidal fractures of Examples 4D-4F was 12.3 micrometers, with a standard deviation of 2.8.

TABLE 1
Major dimension of conchoidal fractures #1-#5 of
Comparative Examples 4A-4C and Examples 4D-4F.

| Comparative | | Comparative | | Comparative | |
|---|---|---|---|---|---|
| Example 4A | | Example 4B | | Example 4C | |
| (FIG. 12A) | | (FIG. 12B) | | (FIG. 12C) | |
| Major | | Major | | Major | |
| dimension | length | dimension | location | dimension | location |
| (um) | (um) | (um) | # | (um) | # |
| 24 | 1 | 21 | 1 | 18 | 1 |
| 17 | 2 | 25 | 2 | 24 | 2 |
| 18 | 3 | 21 | 3 | 19 | 3 |
| 19 | 4 | 21 | 4 | 22 | 4 |
| 20 | 5 | 18 | 5 | 14 | 5 |
| Example 4D | | Example 4E | | Example 4F | |
| (FIG. 12D) | | (FIG. 12E) | | (FIG. 12F) | |
| Major | | Major | | Major | |
| dimension | length | dimension | location | dimension | location |
| (um) | (um) | (um) | # | (um) | # |
| 19 | 1 | 12 | 1 | 15 | 1 |
| 14 | 2 | 10 | 2 | 11 | 2 |
| 14 | 3 | 11 | 3 | 11 | 3 |
| 15 | 4 | 12 | 4 | 10 | 4 |
| 12 | 5 | 11 | 5 | 7 | 5 |

Aspect (1) of this disclosure pertains to a laminate comprising: a first glass ply having first and second opposing surfaces defining a first edge having a first thickness; a second glass ply having third and fourth opposing surfaces defining a second edge having a second thickness that is less than the first thickness; and a polymer layer disposed between the second surface of the first glass ply and the third surface of the second glass ply, wherein the first edge comprises a roughness Ra of less than about 1300 nm, as measured along an area of about 0.5 square millimeters (mm²).

Aspect (2) of this disclosure pertains to the laminate according to Aspect (1), wherein the first edge comprises a root mean square (RMS) roughness of less than about 1700 nm, as measured along the area.

Aspect (3) of this disclosure pertains to the laminate according to any one of Aspect (1) through Aspect (2), wherein the second thickness is in the range from about 0.1 mm up to about 1.6 mm

Aspect (4) of this disclosure pertains to the laminate according to any one of Aspect (1) through Aspect (3), wherein the first thickness is in the range from about 1.6 mm to about 2.5 mm

Aspect (5) of this disclosure pertains to the laminate according to any one of Aspect (1) through Aspect (4), wherein the polymer layer comprises a third edge with a third thickness and a fourth edge opposite the third edge with a fourth thickness greater than the third thickness.

Aspect (6) of this disclosure pertains to the laminate according to any one of Aspect (1) through Aspect (5), wherein the first glass ply is unstrengthened and the second glass ply is strengthened.

Aspect (7) of this disclosure pertains to the laminate according to any one of Aspect (1) through Aspect (6), wherein the second glass ply is chemically strengthened, thermally strengthened, or mechanically strengthened.

Aspect (8) of this disclosure pertains to the laminate according to any one of Aspect (1) through Aspect (7), wherein the second glass ply comprises an alkali aluminosilicate glass.

Aspect (9) of this disclosure pertains to the laminate according to any one of Aspect (1) through Aspect (8), wherein the first glass ply comprises a soda lime glass.

Aspect (10) of this disclosure pertains to the laminate according to any one of Aspect (1) through Aspect (9), wherein the first edge has the RMS is less than about 1000 nm, as measured along the area.

Aspect (11) of this disclosure pertains to the laminate according to any one of Aspect (1) through Aspect (10), wherein the laminate is complexly curved.

Aspect (12) of this disclosure pertains to the laminate according to any one of Aspect (1) through Aspect (11), wherein the second glass ply is strengthened, the third surface comprises a third surface compressive stress and the fourth surface comprises a fourth surface compressive stress that is greater than the third surface compressive stress.

Aspect (13) of this disclosure pertains to a vehicle comprising: a vehicle body; and at least one opening in the vehicle body, and the laminate according to any one of Aspects (1) through Aspect (11), disposed in the at least one opening.

Aspect (14) of this disclosure pertains to a laminate comprising: a first glass ply having first and second opposing surfaces defining a first edge having a first thickness; a second glass ply having third and fourth opposing surfaces defining a second edge having a second thickness that is less than the first thickness; and a polymer layer disposed between the second surface of the first glass ply and the third surface of the second glass ply, wherein the first edge is substantially free of conchoidal fractures having a major dimension greater than 20 micrometers, as measured along an area of 0.60 square micrometers.

Aspect (15) of this disclosure pertains to the laminate according to Aspect (14), wherein the first edge is substantially free of conchoidal fractures having a major dimension greater than 15 micrometers, as measured along an area of 0.60 square micrometers.

Aspect (16) of this disclosure pertains to the laminate according to any one of Aspect (14) through Aspect (15), wherein the second thickness is in the range from about 0.1 mm up to about 1.6 mm.

Aspect (17) of this disclosure pertains to the laminate according to any one of Aspect (14) through Aspect (16), wherein the first thickness is in the range from about 1.6 mm to about 2.5 mm.

Aspect (18) of this disclosure pertains to the laminate according to any one of Aspect (14) through Aspect (17), wherein the polymer layer comprises a third edge with a third thickness and a fourth edge opposite the third edge with a fourth thickness greater than the third thickness.

Aspect (19) of this disclosure pertains to the laminate according to any one of Aspect (14) through Aspect (18), wherein the first glass ply is unstrengthened and the second glass ply is strengthened.

Aspect (20) of this disclosure pertains to the laminate according to any one of Aspect (14) through Aspect (19), wherein the first glass ply comprises a soda lime glass and the second glass ply comprises an alkali aluminosilicate glass.

Aspect (21) of this disclosure pertains to the laminate according to any one of Aspect (14) through Aspect (20), wherein the laminate is complexly curved.

Aspect (22) of this disclosure pertains to the laminate according to any one of Aspect (14) through Aspect (21), wherein the second glass ply is strengthened, the third surface comprises a third surface compressive stress and the fourth surface comprises a fourth surface compressive stress that is greater than the first surface compressive stress.

Aspect (23) of this disclosure pertains to a vehicle comprising: a vehicle body; and at least one opening in the vehicle body, and the laminate according to any one of Aspects (14) through Aspect (22) disposed in the at least one opening.

Aspect (24) of this disclosure pertains to a vehicle comprising: a vehicle body defining an interior; at least one opening in the vehicle body; and a laminate disposed in the at least one opening, the laminate comprising first glass ply facing the interior having first and second opposing surfaces defining a first edge having a first thickness, a second glass ply opposite the first glass ply having third and fourth opposing surfaces defining a second edge having a second thickness that is less than the first thickness; and a polymer layer disposed between the second surface of the first glass ply and the third surface of the second glass ply, wherein the first edge comprises a roughness Ra of less than about 1300 nm and a root mean square (RMS) roughness of less than about 1700 nm, as measured along an area of about 0.5 square millimeters (mm²), and wherein the first edge is substantially free of conchoidal fractures having a major dimension greater than 20 micrometers, as measured along an area of 0.60 square micrometers.

Aspect (25) of this disclosure pertains to the vehicle of Aspect (24), wherein the ratio of the first thickness to the second thickness is in a range from about 1.3:1 to 10:1.

Aspect (26) of this disclosure pertains to the vehicle of Aspect (24) or Aspect (25), wherein the first thickness is in a range from about 1.6 mm to about 3.0 mm, and the second thickness is in a range from about 0.3 mm to up to about 1.6 mm.

Aspect (27) of this disclosure pertains to the vehicle of any one of Aspect (24) through Aspect (26), wherein the first glass ply is unstrengthened and the second glass ply is strengthened.

Aspect (28) of this disclosure pertains to the vehicle of any one of Aspect (24) through Aspect (27), wherein the roughness Rₐ is less than 1000 nm.

Aspect (29) of this disclosure pertains to the vehicle of any one of Aspect (24) through Aspect (28), wherein the root mean square (RMS) roughness is less than about 1000 nm.

Aspect (30) of this disclosure pertains to the vehicle of any one of Aspect (24) through Aspect (29), wherein the first edge is substantially free of conchoidal fractures having a major dimension greater than 15 micrometers, as measured along the area.

Aspect (31) of this disclosure pertains to a method of manufacturing a glass laminate comprising: removing at least one flaw in at least an edge of a thick glass ply to form a treated edge comprising one or both of a roughness Ra of less than about 1300 nm, as measured along an area of about 0.5 square millimeters (mm²), and a root mean square (RMS) roughness of less than about 1700 nm, as measured along an area of about 0.5 square millimeters (mm²), and joining the glass ply comprising the treated edge to a polymer layer and a thin glass ply, wherein the thin glass ply is strengthened and has at thickness of less than about 1.6 mm.

Aspect (32) of this disclosure pertains to the method of Aspect (31), further comprising introducing the at least one flaw to the edge by separating the thick glass ply from a sheet.

Aspect (33) of this disclosure pertains to the method of Aspect (31) or Aspect (32), wherein removing the at least one flaw comprises grinding the edge with a wheel having an abradant finer than 220 grit.

Aspect (34) of this disclosure pertains to the method of any one of Aspect (31) through Aspect (33), wherein the abradant is 400 grit or finer.

Aspect (35) of this disclosure pertains to the method of any one of Aspect (31) through Aspect (34), wherein removing the at least one flaw comprises acid etching, mechanically polishing or acid etching and mechanically polishing the edge.

Aspect (36) of this disclosure pertains to the method of any one of Aspect (31) through Aspect (35), wherein the treated edge is substantially free of conchoidal fractures having a major dimension greater than 20 micrometers, as measured along an area of 0.60 square micrometers.

It will be apparent to those skilled in the art that various modifications and variations can be made without departing from the spirit or scope of the invention.

1. A laminate comprising:
a first glass ply having first and second opposing surfaces defining a first edge having a first thickness;
a second glass ply having third and fourth opposing surfaces defining a second edge having a second thickness that is less than the first thickness; and
a polymer layer disposed between the second surface of the first glass ply and the third surface of the second glass ply,
wherein the first edge comprises a roughness Ra of less than about 1300 nm, as measured along an area of about 0.5 square millimeters (mm²).

2. The laminate of claim 1, wherein the first edge comprises a root mean square (RMS) roughness of less than about 1700 nm, as measured along the area.

3. The laminate of claim 1, wherein the second thickness is in the range from about 0.1 mm up to about 1.6 mm.

4. The laminate of claim 1, wherein the first thickness is in the range from about 1.6 mm to about 2.5 mm.

5. The laminate of claim 1, wherein the polymer layer comprises a third edge with a third thickness and a fourth edge opposite the third edge with a fourth thickness greater than the third thickness.

6. The laminate of claim 1, wherein the first glass ply is unstrengthened and the second glass ply is strengthened.

7. (canceled)

8. The laminate of claim 1, wherein the second glass ply comprises an alkali aluminosilicate glass.

9. (canceled)

10. The laminate of claim 1, wherein the first edge has the Ra or a RMS of about 1000 nm or less, as measured along the area.

11. The laminate of claim 1, wherein the laminate is complexly curved.

12. The laminate of claim 1, wherein the second glass ply is strengthened, the third surface comprises a third surface compressive stress and the fourth surface comprises a fourth surface compressive stress that is greater than the third surface compressive stress.

13. (canceled)

14. A laminate comprising:
a first glass ply having first and second opposing surfaces defining a first edge having a first thickness;
a second glass ply having third and fourth opposing surfaces defining a second edge having a second thickness that is less than the first thickness; and
a polymer layer disposed between the second surface of the first glass ply and the third surface of the second glass ply,
wherein the first edge is substantially free of conchoidal fractures having a major dimension greater than 20 micrometers, as measured along an area of 0.60 square micrometers.

15. The laminate of claim 14, wherein the first edge is substantially free of conchoidal fractures having a major dimension greater than 15 micrometers, as measured along an area of 0.60 square micrometers.

16. The laminate of claim 14, wherein the second thickness is in the range from about 0.1 mm up to about 1.6 mm.

17. The laminate of claim 14, wherein the first thickness is in the range from about 1.6 mm to about 2.5 mm.

18. The laminate of claim 14, wherein the polymer layer comprises a third edge with a third thickness and a fourth edge opposite the third edge with a fourth thickness greater than the third thickness.

19. (canceled)

20. The laminate of claim 14, wherein the first glass ply comprises a soda lime glass and the second glass ply comprises an alkali aluminosilicate glass.

21. The laminate of claim 14, wherein the laminate is complexly curved.

22. The laminate of claim 14, wherein the second glass ply is strengthened, the third surface comprises a third surface compressive stress and the fourth surface comprises a fourth surface compressive stress that is greater than the first surface compressive stress.

23-30. (canceled)

31. A method of manufacturing a glass laminate comprising:
removing at least one flaw in at least an edge of a thick glass ply to form a treated edge comprising one or both of
a roughness Ra of less than about 1300 nm, as measured along an area of about 0.5 square millimeters (mm²)
a root mean square (RMS) roughness of less than about 1700 nm, as measured along an area of about 0.5 square millimeters (mm²), and
joining the glass ply comprising the treated edge to a polymer layer and a thin glass ply, wherein the thin glass ply is strengthened and has at thickness of less than about 1.6 mm.

32. (canceled)

33. The method of claim 31, wherein removing the at least one flaw comprises acid etching the edge, mechanically polishing the edge, acid etching and mechanically polishing the edge, or grinding the edge with a wheel having an abradant finer than 220 grit.

34-36. (canceled)
